(19) United States
(12) Patent Application Publication
(10) Pub. No.: US 2012/0000049 A1
(43) Pub. Date: Jan. 5, 2012

(54) Oil Filter Particle Entrapping Method

(76) Inventor: Reginald Wallace, Madison, FL (US)

(21) Appl. No.: 12/827,659

(22) Filed: Jun. 30, 2010

(51) Int. Cl. B23P 11/00

(52) U.S. Cl. 29/428

(57) ABSTRACT

A method for capturing small metal particles within an oil filter can. The method uses a flexible belt incorporating a number of pockets. Magnets are contained within the pockets, with one magnet per pocket being preferable. The pockets are sealed so that the belt and magnets operate as a unified whole. The belt is wrapped around an oil filter and held in place via the attraction between the magnets and the metal oil filter can. No additional securing mechanism is needed. The belt may be wrapped around oil filters of various sizes with no need for any alterations.

### BACKGROUND OF THE INVENTION

1. Field of the Invention

This invention relates to the field of internal combustion engines. More specifically, the invention comprises a flexible magnetic belt configured to attach to a can-type oil filter in order to attract and retain metallic particles circulating in the oil.

2. Description of the Related Art

FIG. 1 shows a prior art can-type oil filter 10. Can 12 is attached to mounting flange 16 by any suitable method—such as roll crimping. Flange 16 incorporates conventional features allowing oil filter 10 to be attached to an internal combustion engine. Threaded outlet 18 is surrounded by a plurality of radially spaced inlets 20. O-ring 14 surrounds threaded outlet 18 and inlets 20.

FIG. 2 shows a sectioned elevation view of the filter shown in FIG. 1 installed on an internal combustion engine. Engine block 22 includes a threaded mounting spindle 30, which is configured to engage threaded outlet 18 on oil filter 10. The user installs the oil filter by spinning it onto mounting spindle 30. This action compressed O-ring 14 and O-ring 36 against engine block 22, creating a positive seal.

Pressurized oil is fed into inlet manifold 24, from whence it flows through inlets 20 into can 12. The oil is then forced to flow through filter media 32 and into intake cylinder 34 through ports 38. From this point the oil flows up through outlet 26 and thereafter circulates through the engine.

All the features thus described are well known to those skilled in the art. Oil filters in present use contain a variety of internal features and the specific structure shown in FIGS. 1 and 2 is properly viewed as being one example among many possibilities.

It is well known that mechanical forces within internal combustion engines create loose meal particles (“filings”) which circulate in the moving oil. These filings can damage the engine. As the metal particles are usually ferromagnetic (steel or iron), prior art devices have uses magnetism to capture them.

Typical prior art devices use a magnetic sleeve which is sized to fit closely around the external diameter of can 12. Unfortunately, oil filter cans come in a virtually endless variety of sizes. A specific magnetic sleeve must be provided so suit each size or range of sizes. It is therefore desirable to provide a method of magnetically capturing metal particles using a device which can be adapted for use in a wide range of oil filter sizes.

### BRIEF SUMMARY OF THE PRESENT INVENTION

The present invention comprises a method for capturing small metal particles within an oil filter can. The method uses a flexible belt incorporating a number of pockets. Magnets are contained within the pockets, with one magnet per pocket being preferable. The pockets are sealed so that the belt and magnets operate as a unified whole.

The belt is wrapped around an oil filter and held in place via the attraction between the magnets and the metal oil filter can. No additional securing mechanism is needed. The belt may be wrapped around oil filters of various sizes with need for any alterations.

### BRIEF DESCRIPTION OF THE DRAWING VIEW

FIG. 1 is a perspective view, showing a prior art oil filter.

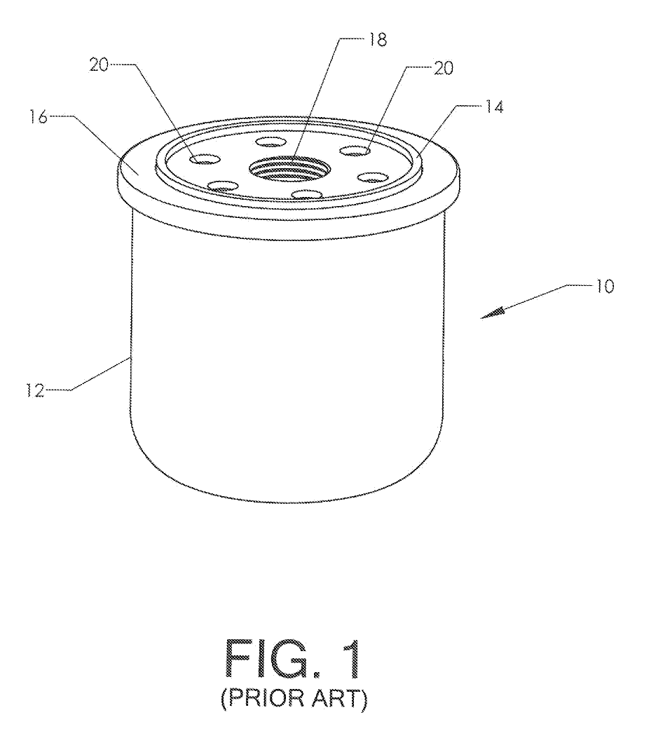

FIG. 2 is a sectional elevation view, showing the oil circulation within a prior art oil filter.

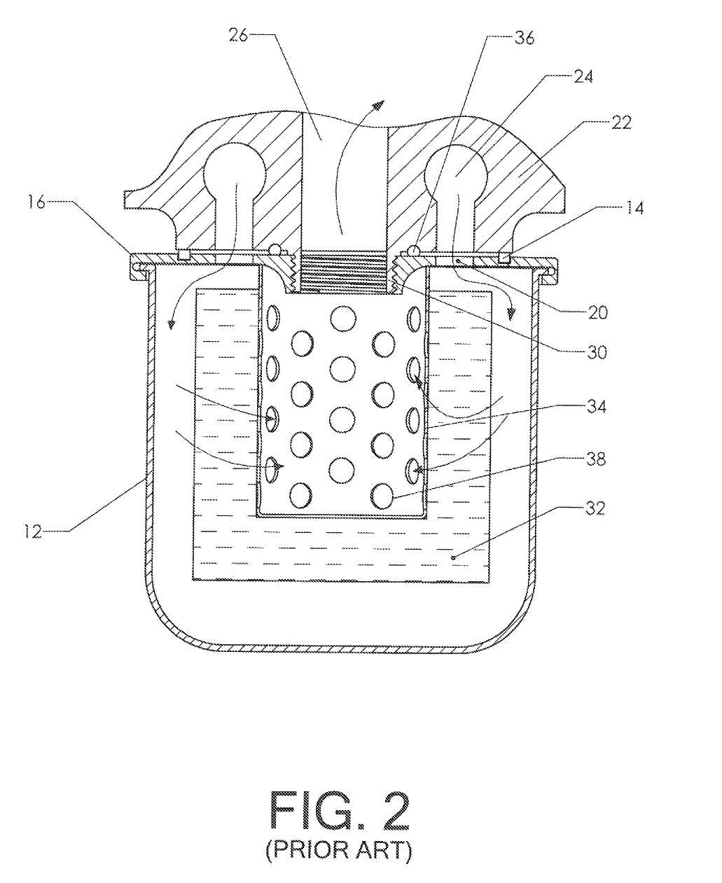

FIG. 3 is a perspective view, showing a magnet belt used in the present invention.

FIG. 4 is an exploded perspective view, showing the magnet belt of FIG. 3 in an exploded state.

FIG. 5 is a sectional elevation view, showing the location of the magnets within the pockets in the belt.

FIG. 6 is a detailed perspective view, showing the structure of the pockets.

FIG. 7 is a perspective view, showing the magnet belt attached to an oil filter.

FIG. 8 is a sectioned elevation view, showing the operation of the magnet belt.

REFERENCE NUMERALS IN THE DRAWINGS

| | |
|---|---|
| 10 oil filter | 12 can |
| 14 O-ring | 16 mounting flange |
| 18 threaded outlet | 20 inlet |
| 22 engine block | 24 inlet manifold |
| 26 outlet | 30 mounting spindle |
| 32 filter media | 34 intake cylinder |
| 36 O-ring | 38 port |
| 40 magnet belt | 42 magnet pocket |
| 44 inner layer | 46 plate magnet |
| 48 outer layer | 50 seam |
| 52 metal particles | |

### DETAILED DESCRIPTION OF THE INVENTION

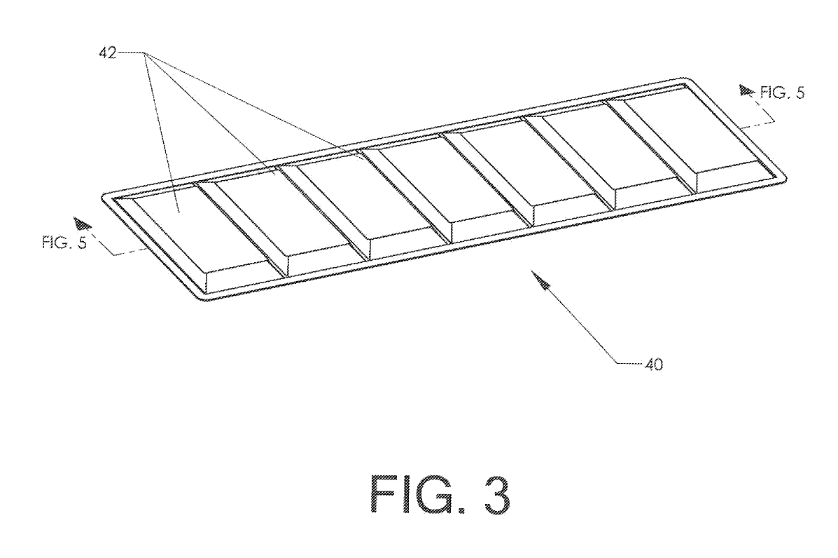

The present inventive method attaches a flexible magnet belt to an oil filter in order to entrap metal particles circulating in the oil. FIG. 3 shows magnet belt 40 in an assembled state. The belt is flexible so that it may be wrapped around oil filters of different sizes. A plurality of magnet pockets 42 are provided along the length of the belt. Each pocket preferably contains one or more magnets.

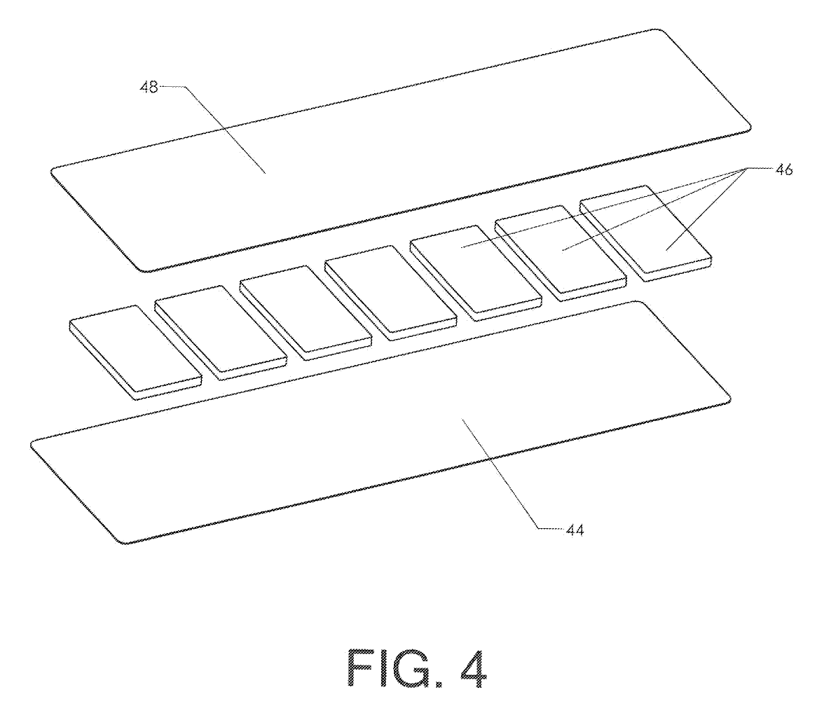

The magnet belt can be made in a variety of different ways. FIGS. 4 through 6 illustrate one exemplary approach. Inner layer 44 is laid flat. A suitable number of magnets (in this case plate magnets 46) is then place don top of inner layer 44.

Outer layer 48 is then placed over inner layer 44 and plate magnets 46. It is desirable to retain the plate magnets in an even spacing. In order to do this each plate magnet is contained within a pocket in this embodiment.

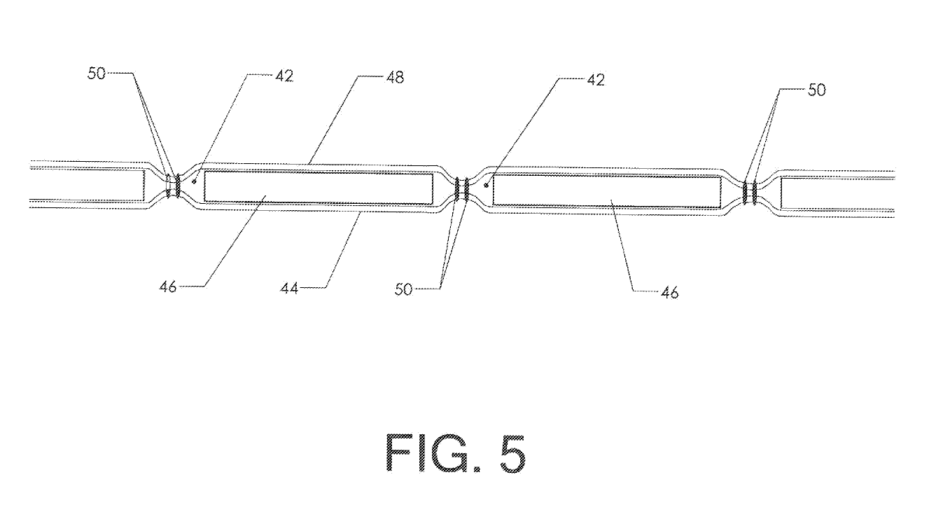

FIG. 5 is a section view through the completed assembly shown in FIG. 3. The reader will note that outer layer 48 has been attached to inner layer 44 along seams 50, thereby creating pockets 42.

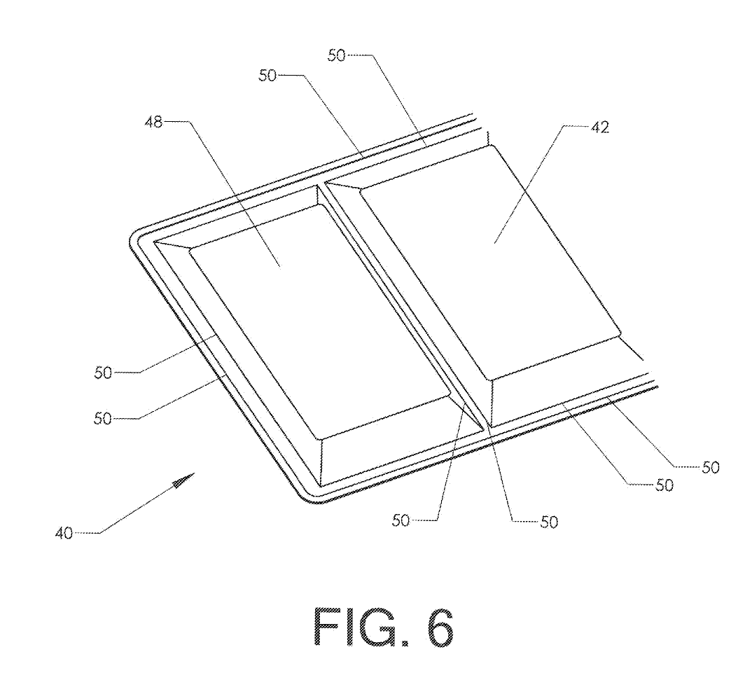

FIG. 6 is a perspective view of the same assembly. Seams 50 are formed around each magnet in order to isolate each magnet in its own pocket and retain it in the desired location along the length of the belt.

The seams may be formed using any suitable technology, including: (1) stitching the inner and outer layers together; (2) using meltable materials for the inner and outer layers and melting the seams together; and (3) screen printing a suitable adhesive along the locations of the desired seams and pressing the two layers together so that the adhesive forms a bond. Other techniques will readily occur to those skilled in the art and the particular method used to create the seams and pockets is not critical to the present invention.

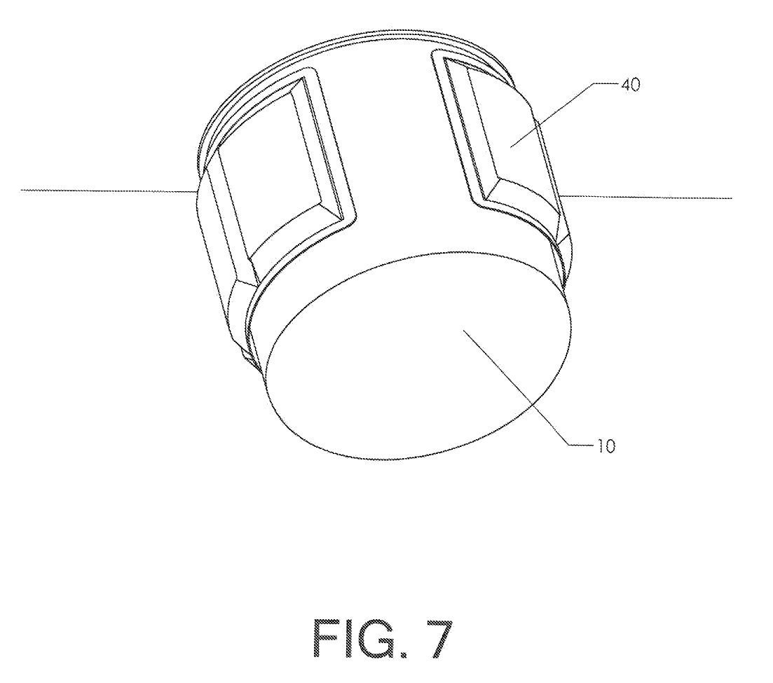

Once assembled, the magnet belt is touch and durable. FIG. 7 shows magnet belt 40 in use in the present inventive method. The user wraps the belt around the cylindrical wall of oil filter 10. Because the oil filter's can is made of steel, the magnets within the belt adhere strongly to its exterior. The magnetic attraction alone is sufficient to retain the belt in the position shown during the operation of the internal combustion engine to which the oil filter is attached.

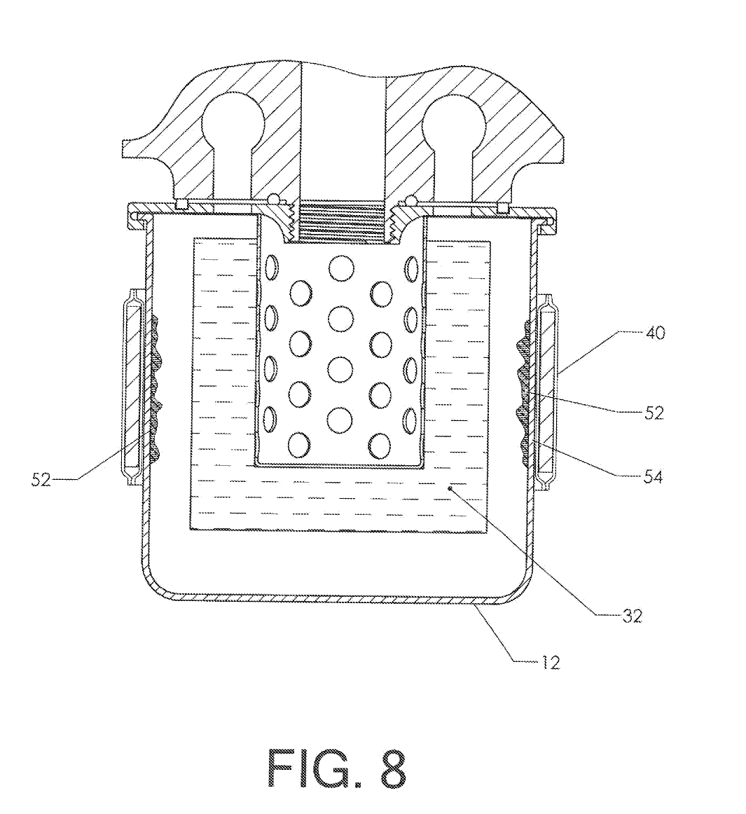

FIG. 8 shows a sectional elevation view through the oil filter with magnet belt 40 attached. The oil circulates through the filter as described in the prior art. However, metal particles 52 are retained within the filter via the magnetic attraction of magnet belt 40. These particles accumulate along the interior of cylindrical wall 54. Filter media 32 is able to retain larger metal particles on its own. The use of the magnet belt, though, retains much smaller particles and thereby enhances filtration.

Returning to FIG. 7, the reader will observe that magnet belt 40 is not quite long enough to pass completely around the can of oil filter 10. The gap shown does not significantly affect performance. Thus, the belt may be used effectively on oil filter cans that are much too large for the belt to pass completely around.

Of course, if a small diameter filter is present, the magnet belt may wrap around more than one complete turn and actually overlap itself. In this case, one end of the belt will overlie the other. The magnets in the overlapping portion will then align with the magnets in the portion beneath. The flexibility of the material used for the inner and outer layers of the belt allows the magnet to move laterally so that this alignment occurs with no action by the user. The flexibility also allows the user to bunch the magnets closer together so that the spacing between magnets can be varied to suit different filter applications.

Those skilled in the art will know that an oil filter can is subjected to high temperatures (45 to 95 degrees Centigrade), vibration, dust, and other hazards. The materials for the belt should be selected with these hazards, in mind. High temperature, flexible plastic sheeting is suitable. A flexible, UV-resistant polyvinyl chloride is one example of a suitable material. Many other natural and synthetic materials could be substituted. Likewise, any adhesive used to bond the layers or thread used to stitch the seams must be suitable for the environment. Silicone-based adhesives are one good example.

Although the preceding description contains significant detail, it should not be construed as limiting the scope of the invention but rather as providing illustrations of the preferred embodiments of the invention. The inventive method could be realized in many different ways. As one example, inner layer 44 and/or outer layer 48 may be formed of multiple pieces rather than one piece of continuous material. For instance, outer layer 48 could be seven individual pieces—with one piece being present for each pocket. Thus, the examples provided are properly viewed as embodiments of the invention rather than a definition of the invention's scope.

Having described my invention, I claim:

1. A method for entrapping metal particles within an oil filter, said oil filter including a cylindrical wall, comprising:
a. providing a magnet belt, including
i. an inner layer,
ii. an outer layer,
iii. a plurality f plate magnets located between said inner layer and said outer layer,
iv. each of said plurality of plate magnets lying within a pocket formed by joining said inner layer to said outer layer, wherein one pocket is formed for each of said plate magnets; and
b. wrapping said magnet belt around said cylindrical wall of said oil filter with said inner layer contacting said cylindrical wall.

2. A method for entrapping metal particles within an oil filter as recited in claim 1, wherein said inner layer is joined to said outer layer by stitching.

3. A method for entrapping metal particles within an oil filter as recited in claim 2, wherein:
a. each of said plate magnets has a perimeter; and
b. each of said pockets is formed by stitching said inner layer to said outer layer around said perimeter of each of said plate magnets.

4. A method for entrapping metal particles within an oil filter as recited in claim 1, wherein:
a. each of said plate magnets has a perimeter; and
b. each of said pockets is formed by melting said inner layer and said outer layer together around said perimeter of each of said plate magnets.

5. A method for entrapping metal particles within an oil filter as recited in claim 1, wherein:
a. each of said plate magnets has a perimeter; and
b. each of said pockets is formed by placing an adhesive between said inner layer and said outer layer around said perimeter of each of said plate magnets.

6. A method for entrapping metal particles within an oil filter as recited in claim 1, wherein said inner layer is made of one piece of continuous material and said outer layer is made of one piece of continuous material.

7. A method for entrapping metal particles within an oil filter as recited in claim 1, wherein said outer layer is made of multiple pieces of material.

8. A method for entrapping metal particles within an oil filter, said oil filter including a cylindrical wall, comprising:
a. providing a magnet belt, including
i. a flexible inner layer,
ii. a plurality of pockets connected to said flexible inner layer,
iii. a plurality of magnets, wherein each of said magnets lies in one of said plurality of pockets; and
b. wrapping said magnet belt around said cylindrical wall of said oil filter with said inner layer contacting said cylindrical wall.

9. A method for entrapping metal particles within an oil filter as recited in claim 1, wherein said pockets are connected to said inner layer by stitching.

10. A method for entrapping metal particles within an oil filter as recited in claim 9, wherein:
a. each of said magnets has a perimeter; and
b. each of said pockets is formed by stitching said pocket to said inner around said perimeter of each of said plate magnets.

11. A method for entrapping metal particles within an oil filter as recited in claim 9, wherein:
a. each of said magnets has a perimeter; and
b. each of said pockets is connected to said inner by melting said pocket and said inner layer together around said perimeter of each of said magnets.

12. A method for entrapping metal particles within an oil filter as recited in claim 9, wherein:
a. each of said magnets has a perimeter; and
b. each of said pockets is formed by placing an adhesive between said inner layer and said pocket around said perimeter of each of said magnets.

13. A method for entrapping metal particles within an oil filter as recited in claim 9, wherein said inner layer is made of one piece of continuous material and said pockets are made of one piece of continuous material.

14. A method for entrapping metal particles within an oil filter as recited in claim 9, wherein said pockets are made of multiple pieces of material.

15. A method for entrapping metal particles within an oil filter said oil filter including a cylindrical wall, comprising:
a. providing a flexible magnet belt having an inner layer, said magnet belt including a plurality of magnets, with each of said magnets being enclosed within a pocket connected to said inner layer; and
b. wrapping said magnet belt around said cylindrical wall of said oil filter with said inner layer contacting said cylindrical wall.

16. A method for entrapping metal particles within an oil filter as recited in claim 15, wherein said pockets are connected to said inner layer by stitching.

17. A method for entrapping metal particles within an oil filter as recited in claim 15, wherein:
a. each of said magnets has a perimeter; and
b. each of said pockets is formed by stitching said pocket to said inner around said perimeter of each of said plate magnets.

18. A method for entrapping metal particles within an oil filter as recited in claim 15, wherein:
a. each of said magnets has a perimeter; and
b. each of said pockets is connected to said inner by melting said pocket and said inner layer together around said perimeter of each of said magnets.

19. A method for entrapping metal particles within an oil filter as recited in claim 15, wherein:
a. each of said magnets has a perimeter; and
b. each of said pockets is formed by placing an adhesive between said inner layer and said pocket around said perimeter of each of said magnets.

20. A method for entrapping metal particles within an oil filter as recited in claim 15, wherein said inner layer is made of one piece of continuos material and said pockets are made of one piece of continuous material.
